(19) United States
(12) Patent Application Publication
(10) Pub. No.: US 2022/0270352 A1
(43) Pub. Date: Aug. 25, 2022

(54) METHODS, APPARATUSES, DEVICES, STORAGE MEDIA AND PROGRAM PRODUCTS FOR DETERMINING PERFORMANCE PARAMETERS

(71) Applicant: Beijing Sensetime Technology Development Co., Ltd., Beijing (CN)

(72) Inventors: Yuanhan ZHANG, Beijing (CN); Zhenfei YIN, Beijing (CN); Guojun YIN, Beijing (CN); Jing SHAO, Beijing (CN)

(21) Appl. No.: 17/740,968

(22) Filed: May 10, 2022

Related U.S. Application Data
(63) Continuation of application No. PCT/CN2020/130377, filed on Nov. 20, 2020.

(30) Foreign Application Priority Data
May 9, 2020 (CN) 202010388252.1

(51) Int. Cl. G06V 10/776; G06V 40/40; G06V 40/16; G06V 10/82; G06V 10/774

(52) U.S. Cl. CPC G06V 10/776; G06V 40/45; G06V 40/161; G06V 10/82; G06V 10/774

(57) ABSTRACT

Methods, apparatuses, devices, storage media and program products for determining parameters of a neural network are provided. In one aspect, a computer-implemented method includes: acquiring a first dataset that includes a plurality of face images, obtaining a liveness classification result and a detection result of each of the plurality of face images by inputting the face image into the neural network, and determining performance parameters of the neural network according to a plurality of detection results of the plurality of face images.

### CROSS-REFERENCE TO RELATED APPLICATION

The present application is a continuation of International Application No. PCT/CN2020/130377, filed on Nov. 20, 2020, which claims priority to Chinese Patent Application No. 202010388252.1, filed on May 9, 2020 and entitled “METHODS, APPARATUSES, DEVICES, ELECTRONIC EQUIPMENTS AND STORAGE MEDIUM FOR DETERMINING PERFORMANCE PARAMETERS”, all of which are incorporated herein by reference in their entireties.

### TECHNICAL FIELD

The present disclosure relates to computer vision technology, and in particular, to methods, apparatuses, devices, storage media and program products for determining performance parameters.

### BACKGROUND

With the development of computer vision technology, a growing number of work can be done with electronic equipment, which provides people with convenient conditions. For example, electronic equipment can be used to automatically recognize a person's face, so as to verify a user's identity according to a result of the face recognition. However, with popularization of face recognition technology, a variety of spoofing used in face recognition technology also follow, for example, by using a photo, a mask, etc. as a user's face to pass verification of user identity.

In order to resist various spoofing, liveness detection has become an important part of face recognition technology. Liveness detection is technology of determining whether a detected object is a real living one or not in some identification scenarios. For example, based on a combination of actions such as blinking, opening mouth, shaking head, nodding, and other actions, it can verify whether the detected object is a real living one or not, so as to identify fraud and improve the security of face recognition. For this reason, there are various means of liveness detection, for example, there are various network models for liveness detection. Performance of each network model varies.

### SUMMARY

The present disclosure provides a technical solution for determining performance parameters.

According to a first aspect of the present disclosure, a method of determining performance parameters is provided, which includes: acquiring a first dataset which includes a plurality of face images; for each of the plurality of face images, obtaining a liveness classification result and a detection result of the face image by inputting the face image into a neural network; determining performance parameters of the neural network according to a plurality of detection results.

According to a second aspect of the present disclosure, an apparatus for determining performance parameters is provided, which includes: a first acquisition unit configured to acquire a first dataset which includes a plurality of face images; a detector configured to, for each of the plurality of face images, obtain a liveness classification result and a detection result of the face image by inputting the face image into a neural network; a determination unit, configured to determine performance parameters of the neural network according to a plurality of detection results.

According to a third aspect of the present disclosure, an electronic device is provided, which includes a processor; a memory for storing instructions executable by the processor, the processor is configured to invoke the instructions to implement the method of determining performance parameters in the first aspect.

According to a fourth aspect of the present disclosure, a non-transitory computer-readable storage medium is provided, wherein the storage medium stores computer program instructions, when the computer program instructions are executed by a processor, the processor is caused to implement the method of determining performance parameters in the first aspect.

According to a fifth aspect of the present disclosure, a computer program including computer readable codes is provided, when the computer readable codes are run on a device, a processor in the device executes instructions for implementing the method in the first aspect.

In the embodiment of the present disclosure, a first dataset which includes a plurality of face images can be acquired, then for each of the plurality of face images, a liveness classification result and a detection result of the face image can be obtained by inputting the face image into a neural network, furthermore performance parameters of the neural network can be determined based on a plurality of detection results. Generally, performance parameters of a neural network can reflect performance of the neural network, in the implementation provided by the present disclosure, the performance of the neural network can be evaluated by using the determined performance parameters. Since a plurality of dimensions of data are obtained through the neural network, that is, the liveness classification result and the detection result corresponding to a face image, the performance parameters can be determined by combining the plurality of dimensions of data, such that the performance parameters can effectively reflect the actual performance of the neural network. In the process of applying the method, weight parameters of the neural network can also be adjusted with the help of performance parameters, so as to improve accuracy of liveness detection and make the neural network suitable for more complex application scenarios.

It should be understood that the above general description and the following detailed description are only exemplary and explanatory, rather than limiting the present disclosure.

### BRIEF DESCRIPTION OF THE DRAWINGS

The accompanying drawings, which are incorporated in and constitute a part of this specification, illustrate examples consistent with the present disclosure, and together with the description, serve to explain the solutions of the disclosure.

FIG. 1 is a flowchart illustrating a method of determining performance parameters according to embodiments of the present disclosure.

FIG. 2A is an exemplary diagram illustrating a process of determining performance parameters according to embodiments of the present disclosure.

FIG. 2B is another exemplary diagram illustrating a process of determining performance parameters according to embodiments of the present disclosure.

FIG. 3 is a block diagram illustrating an apparatus for determining performance parameters according to embodiments of the present disclosure.

FIG. 4 is a block diagram illustrating an exemplary device for determining performance parameters according to embodiments of the present disclosure.

FIG. 5 is a block diagram illustrating an electronic device according to embodiments of the present disclosure.

### DETAILED DESCRIPTION OF THE EMBODIMENTS

Various exemplary embodiments, features and aspects of the present disclosure will be described in detail below with reference to the accompanying drawings. The same reference signs in the drawings indicate elements with the same or similar functions. Although various aspects of the embodiments are shown in the drawings, unless otherwise noted, the drawings are not necessarily drawn to scale.

The dedicated word “exemplary” here indicates “used as an example, an embodiment or an illustration”. Herein, any embodiment described as “exemplary” is not necessarily construed as superior to or better than other embodiments.

The term “and/or” in the present disclosure is merely an association relationship for describing associated objects, and indicates that there may be three association relationships, for example, A and/or B may indicate that there are three cases: A alone, both A and B, and B alone. In addition, the term “one or more” herein indicates any one of a plurality or any combination of at least two of the plurality. For example, including one or more of A, B, and C, can indicate that including any one or more elements selected from a set of A, B, and C.

In addition, numerous specific details are given in the following specific embodiments to better illustrate the present disclosure. Those skilled in the art should understand that the present disclosure can also be implemented without certain specific details. In some examples, the methods, means, elements, and circuits that are well known to those skilled in the art are not described in detail in order to highlight the gist of the present disclosure.

According to a scheme of determining performance parameters provided by the present disclosure, a first dataset which includes a plurality of face images can be acquired, then for each of the plurality of face images, a liveness classification result and a detection result of the face image can be obtained by inputting the face image into a neural network, furthermore performance parameters of the neural network can be determined according to a plurality of detection results. The determined performance parameters can be used to evaluate performance of the neural network, thereby providing reference for selection or improvement of the neural network.

In an example, when performing liveness detection on a face image with a neural network, the neural network can only output a liveness classification result of the face image, and it is difficult to judge accuracy of the liveness classification result. For example, in the case of malicious spoofing, it is difficult to judge the accuracy of the liveness classification result and unable to determine the accuracy of the neural network, so that the security of face recognition cannot be guaranteed. In a solution for determining performance parameters provided by the present disclosure, a liveness classification result and a detection result can be obtained, the performance parameters of the neural network can be determined based on the detection result, and the performance parameters can be used as effective reference for evaluating the performance of the neural network. Therefore, based on the determined performance parameters, weight parameters of the neural network can be adjusted to improve the accuracy of the neural network, so that a liveness classification result outputted by the neural network can be more accurate. The neural network may be a convolution neural network or other types of neural network, which is not limited by the present disclosure.

Technical solutions provided by examples of the present disclosure may be applicable to extension of application scenarios such as face recognition, face unlocking, face payment, security and so on, which are not limited by examples of the present disclosure. For example, performance of a neural network used for face unlocking can be evaluated to improve accuracy of face unlocking.

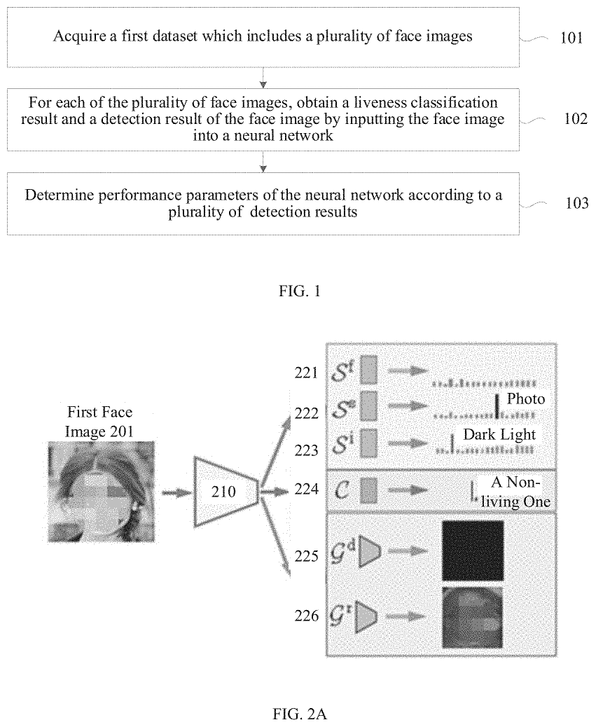

FIG. 1 is a flowchart illustrating a method of determining performance parameters according to embodiments of the present disclosure. The method of determining performance parameters may be executed by a terminal device, a server or other types of electronic devices, where the terminal device may be a UE (User Equipment), a mobile device, a user terminal, a terminal, a cellular phone, a cordless phone, a PDA (Personal Digital Assistant), a handheld device, a computing device, an in-vehicle device, a wearable device, etc. In some possible implementations, the method of determining performance parameters may be implemented with a processor by invoking computer-readable instructions stored in a memory. In the following, description of the method of determining performance parameters in the present disclosure will be given with reference to an example in which an execution entity is an electronic device.

At step 101, a first dataset which includes a plurality of face images is acquired.

In the embodiments of the present disclosure, the first dataset may be a pre-constructed dataset, and the first dataset may include a plurality of face images. A face image may be obtained by acquiring a face in a scene, or may be a face image to be detected which is obtained from other devices or datasets, for example, a face image obtained from a device such as a camera device, a monitoring device or a network server. The plurality of face images include real face images and unreal face images. The real face images may be face images obtained by performing image acquisition on real faces; and the unreal face images may be face images obtained by performing image acquisition on unreal faces, for example, the unreal face images may be obtained by performing image acquisition on photos, posters, etc.

At step 102, for each of the plurality of face images, a liveness classification result and a detection result of the face image can be obtained by inputting the face image into a neural network.

In the embodiments of the present disclosure, each of the plurality of face images in the first dataset is input into the neural network in turn to obtain a liveness classification result and a detection result of the face image output by the neural network. Parameters of the neural network can be obtained by training the neural network with a sample set. The neural network may include a plurality of output branches, where one output branch can be used to output a liveness classification result of a face image, and the other output branches can be used to output a detection result of the face image. The liveness classification result can indicate a judgement result of discerning whether a face in a face image belongs to a living one or not. For example, the liveness classification result can indicate a face in a face image belongs to a living one or does not belong to a living one. The detection result can indicate a detection result of a related detecting item for liveness detecting. For example, the detection result can indicate a detection result of gender, age and other attributes of human beings in a face image.

At step 103, performance parameters of the neural network can be determined according to a plurality of detection results.

In the embodiments of the present disclosure, the performance parameters of the neural network can be determined based on the plurality of detection results output by the neural network. Generally, performance parameters of a neural network can reflect performance of the neural network, such that the determined performance parameters can be used to evaluate the performance of the neural network. For example, accuracy of a neural network can be evaluated by verifying the liveness classification result based on the detection results. Taking an example that the performance parameters include an accuracy rate, in a case where a liveness classification result indicates that a face in a face image belongs to a living one, while a detection result indicates that a detecting item corresponding to a non-living one is detected, the liveness classification result can be considered not accurate enough. Thus, the performance of the neural network can be evaluated by counting the respective accuracy of liveness classification results of a plurality of face images. The performance parameters may also include a false detecting rate, a recalling rate and other parameters that can be used to evaluate performance of a neural network, and the specific content of performance parameters is not limited in the present disclosure.

For each of the plurality of face images included in the first dataset, the liveness classification result and detection result of the face image can be obtained by inputting the face image into the neural network, and the performance parameters of the neural network can be determined based on the detection results. Furthermore, the performance of the neural network can be evaluated with the determined performance parameters, so as to improve the accuracy of liveness detecting.

In some possible implementations, the detection result can include relevant data used to determine whether a face in the face image belongs to a living one or not, such that the corresponding liveness classification result can be verified or the accuracy of the liveness classification result can be evaluated based on the detection results, or more information about the liveness detecting can be obtained based on the detection results, making the information output from the neural network more complete.

In an example, the detection result includes at least one of: a face attribute, a spoof type, an illumination condition, imaging environment, depth information, or reflection information, so as to make liveness detecting items related to the neural network much more complete.

The face attribute may represent features of a person and/or a face in a face image, for example, the face attribute may include information such as gender of the person, hair color of the person, facial expression, etc.

The spoof type may include a medium for generating a face image. For example, the spoof type may include using an image from a photo, a poster or print paper, etc., which indicates that a face image is obtained by photographing the photo, poster or printed paper, etc.

The illumination condition may include a lighting condition during a process of acquiring a face image. For example, the illumination condition may include normal light, strong light, backlighting, dark light, and so on, which indicates that the face image is captured under normal light, strong light, backlighting, dark light, and so on. Light intensity of the normal light can be between first light intensity and second light intensity, where the second light intensity is greater than the first light intensity; light intensity of the strong light can be greater than or equal to the second light intensity; and light intensity of the dark light can be less than or equal to the first light intensity. The first light intensity and the second light intensity can be set according to empirical values. Backlighting can indicate a way of shooting towards a light source.

The imaging environment may include environment in which a face image is taken. For example, the imaging environment may include indoor environment, outdoor environment, etc., which indicates that the face image is taken in the indoor environment or the outdoor environment.

The depth information may represent an image depth of a face image, and may include a depth map of the face image. Generally, a real face image has a plurality of depth values, and a difference between the plurality of depth values is greater than a depth threshold, which indicates that a face in the real face image does not belong to a same plane, that is to say, the face in the real face image is stereoscopic. While for an unreal face image, the unreal face image may have only one depth value, or a lot of depth values being closed with each other, and a difference between the depth values is less than or equal to the depth threshold, which indicates that a face in the unreal face image belongs to a same plane. In this way, depth information of a face image can be used as relevant data for liveness detecting.

The reflection information may represent light reflection of a face image, and can include a reflection map of the face image. As a real face diffuses light, a real face image obtained by capturing a real face has less light reflection. While for an unreal face image, the unreal face image may belong to a same plane, for example, an unreal face image can be a face image obtained by shooting a photo, therefore an unreal face image has more light reflection. In this way, reflection information of a face image can be used as relevant data for liveness detecting.

In some possible implementations, the plurality of face images can include respective annotation information. In a case of evaluating the performance of the neural network according to the detection results, for each of the plurality of face images, a comparison result corresponding to the face image can be obtained by comparing the detection result of the face image with annotation information of the face image. Then the performance parameters of the neural network can be determined according to the comparison results corresponding to at least a portion of the plurality of face images.

For example, each of the plurality of face images may include annotation information. The annotation information may include real information related to the liveness detection for the face image, which includes one or more of the face attribute, spoof type, illumination condition and imaging environment. A comparison result representing accuracy of the detection result of the face image can be obtained by comparing the detection result of the face image with the annotation information of the same face image. Furthermore, the performance parameters of the neural network can be determined according to comparison results corresponding to at least a portion of the plurality of face images. For example, accuracy of one or more results included in the detection results of the neural network can be determined according to comparison results corresponding to part or all of the plurality of face images.

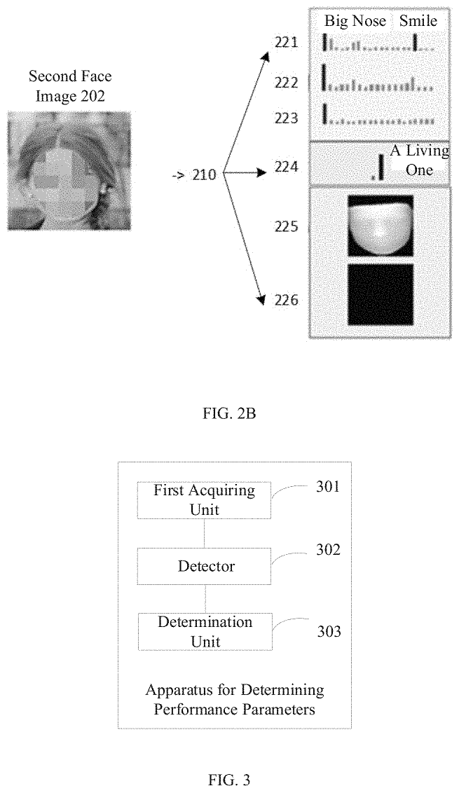

A process of determining performance parameters provided by embodiments of the present disclosure is described below by an example. FIG. 2A and FIG. 2B are exemplary diagrams illustrating a process of determining performance parameters according to embodiments of the present disclosure. A first face image 201 can be assumed as an unreal face image, and a second face image 202 can be assumed as a real face image. A plurality of pieces of information is output by a neural network 210, where S^{f} can represent a face attribute 221, S^{S} can represent a spoof type 222, Sⁱ can represent an illumination condition 223, C can represent a liveness classification result 224, G^{d} can represent depth information 225, and G^{r} can represent reflection information 226.

As shown in FIG. 2A, a detection result and a liveness classification result of the first face image 201 can be obtained by inputting the first face image 201 into the neural network 210. Detection values corresponding to the face attribute 221 are relatively low (less than a face threshold), which can be understood as no obvious face attribute being detected, indicating that a face attribute of the first face image 201 belongs to a face attribute of an unreal face image. A detection value corresponding to the spoof type 222 is relatively high (greater than a spoofing threshold), which can be understood as a spoof type as a photo being detected, indicating that a spoof type of the first face image 201 belongs to a spoof type as a photo of an unreal face image. A detection value corresponding to dark light is relatively high (greater than an illumination threshold), which can be understood as an illumination condition as dark light being detected, indicating that an illumination condition of the first face image 201 belongs to an illumination condition as dark light of an unreal face image. The liveness classification result 224 represents that a non-living one is detected, which indicates that the first face image 201 belongs to an unreal face image. There is only one black depth value in a depth map of the depth information 225, which can be understood as a face in the first face image 201 being on a plane, indicating that the first face image 201 belongs to an unreal face image. A reflection map of the reflection information 226 illustrates strong light reflection, which can be understood as a face in the first face image 201 being on a plane, indicating that the first face image 201 belongs to an unreal face image. By comprehensive analyzing the liveness classification result of the first face image 201 and a plurality of pieces of information included in the detection result of the first face image 201, the neural network 210 can be used to perform liveness detection on the first face image 201. For example, one or more pieces of information selected from the detection result and the liveness classification result of the first face image 201 can be taken as basis for judging whether a face in the first face image 201 belongs to a living one or not; or, among the liveness classification result and the plurality of pieces of information included in the detection result, if the number of pieces of the information indicating that the first face image 201 belongs to an unreal face image is greater than or equal to a preset number, a face in the first face image can be determined as not belonging to a living one.

Correspondingly, as shown in FIG. 2B, which is similar to the process of performing liveness detection on the first face image 201 with the neural network, a detection result and a liveness classification result of a second face image 202 can be obtained by inputting the second face image 202 into the neural network 210. The face attribute 221 represents face attributes as big nose and smile being detected (detection values are greater than the face threshold), which indicates that a face attribute of the second face image 202 belongs to a face attribute of a real face image. The spoof type 222 represents no spoof type being detected (detection values are less than the spoofing threshold), indicating that there is no corresponding spoof type and the second face image 202 belongs to a real face image. The illumination condition 223 represents no illumination condition being detected (detection values are less than the illumination threshold), indicating that there is no corresponding illumination condition and the second face image 202 belongs to a real face image. The liveness classification result 224 represents that a living one is detected, which indicates that the second face image 202 belongs to a real face image. Meanwhile there are a plurality of depth values in a depth map of the depth information 225, which indicates that the second face image 202 belongs to a real face image. There is no light reflection in a reflection map of the reflection information 226, which indicates that the second face image 202 belongs to a real face image. By comprehensive analyzing the liveness classification result of the second face image 202 and a plurality of pieces of information included in the detection result of the second face image 202, the neural network 210 can be used to perform liveness detection on the second face image 202. For example, one or more pieces of information selected from the detection result and the liveness classification result of the second face image 202 can be taken as basis for judging whether a face in the second image 202 belongs to a living one or not; or, among the liveness classification result and the plurality of pieces of information included in the detection result, if the number of pieces of the information indicating that the second face image 202 belongs to a real face image is greater than or equal to the preset number, a face in the second face image 202 can be determined as belonging to a living one.

Furthermore, it is possible to compare the detection result of the first face image with annotation information of the first face image, and compare the detection result of the second face image with annotation information of the second face image, then the performance parameters of the neural network can be determined based on comparison results. For example, performance parameters of a neural network can be obtained by determining accuracy for each detection item of the detection result, then performance of the neural network can be evaluated according to the determined performance parameters.

In the embodiments of the present disclosure, an evaluation result can be obtained by evaluating performance of the neural network based on the determined performance parameters, such that the performance of the neural network can be further improved based on the evaluation result. A process for improving performance of a neural network will be described below in one or more implementations.

In some possible implementations, a second dataset which includes a plurality of training samples can be obtained based on the evaluation result. The training samples may include face images. Then, each of the plurality of training samples can be input into the neural network to obtain a detection result corresponding to the training sample. Furthermore, weight parameters of the neural network can be adjusted based on degree of difference between detection results with respect to at least a portion of the training samples and annotation information with respect to the at least a portion of the training samples.

In this implementation, a plurality of training samples related to the evaluation result can be obtained from the second dataset based on the evaluation result. For example, if the evaluation result indicates that accuracy of one or more detection results of the neural network is relatively low, such as accuracy of a detection result of the spoof type is relatively low, a plurality of training samples related to the spoof type can be obtained from the second dataset, such that the neural network can be trained focusing on the spoof type to improve the accuracy of the neural network for a detection item of the spoof type. The second dataset may include an enormous number of training samples. Each training sample may include corresponding annotation information, and the annotation information can be used to annotate a face involved in the training sample, where the annotation information includes one or more items of a face attribute, a spoof type, an illumination condition, and imaging environment. In a case of training a neural network, for each training sample, a detection result of the training sample output by the neural network can be obtained by inputting the training sample into the neural network. Then degree of difference between a detection result of the training sample and annotation information of the training sample can be determined by comparing the detection result of the training sample with the annotation information of the same training sample. For example, for each detection item, degree of difference between a result of the detection item and corresponding annotation information is determined. After that, for each training sample, the degree of difference between the detection result of the training sample and the annotation information of the training sample can be obtained by adding or weighted calculating each degree of difference between a result of a detection item and corresponding annotation information. Based on optimization algorithms such as a gradient descent algorithm, multiple degree of difference between the detection result and the annotation information with respect to training samples can be back-propagated to the neural network as batches, so as to continuously adjust and optimize the weight parameters of the neural network, which makes detection results output from the neural network more accurate, and finally a neural network with improved performance can be obtained. Cross-entropy loss function, binary cross-entropy loss function, or the like can be used to determine the degree of difference between the detection result and the annotation information of the training sample.

The neural network may be a common liveness detection neural network, or may be a neural network constructed based on new designed architecture of neural network. For example, the neural network may include at least one convolutional layer, at least one pooling layer, at least one fully connected layer, and so on. Image sizes of training samples input into the neural network can be uniform. For example, a training sample with an image size of 224*224 pixels can be input into the neural network. If the image sizes of the training samples are different, the training samples can also be input into the neural network after being cropped to a fixed image size.

In some examples of this implementation, both the first dataset and the second dataset include real face images and unreal face images. Annotation information of a real face image includes a liveness classification result and face attributes. Annotation information of an unreal face image includes a liveness classification result and one or more of the following: the spoof type, the illumination condition, or the imaging environment.

In the examples of the present disclosure, both the first dataset and the second dataset include real face images and unreal face images. A real face image may involve a real face, that is, the real face image may be an image obtained by acquiring a real person's face. Annotation information of the real face image may include a liveness classification result and face attributes, where the liveness classification result may represent a living one, and the face attributes may indicate information such as gender of the real person, hair color of the real person, and facial expression of the real person. An unreal face image may involve an unreal face, that is, the unreal face image may be an image obtained by forging a real face, for example, the unreal face image may be an image obtained by acquiring a poster with a face involved in, such as, taking a photo for the poster. Annotation information of the unreal face image may include a liveness classification result and one or more items of the spoof type, the illumination condition, and the imaging environment. This liveness classification result may represent a non-living one. The spoof type may include a photo, a poster, a printing paper, etc. The illumination condition may include normal light, strong light, backlighting, dark light, etc. The imaging environment may include indoor environment, outdoor environment, etc. By setting annotation information including various kinds of annotation for the training samples, a trained neural network can be adapted to more application scenarios.

In this example, different tags may be set for different annotation items included in the annotation information. In a case where an annotation item may include a plurality of sub-annotation items, the plurality of sub-annotation items may be distinguished by subscript or superscript of a tag. For example, the spoof type can be represented by S^{S}, and a spoof type as the poster can be represented by S^{S1}.

In some examples, the number of real face images included in the second dataset may be less than the number of unreal face images included in the second dataset. For example, a ratio of the number of real face images included in the second dataset to the number of unreal face images included in the second dataset may be set to 1:3. By setting the number of unreal face images included in the second dataset to be greater than the number of real face images included in the second dataset, the second dataset can provide more unreal face images, so that the second dataset can be suitable for exploring a variety of liveness forgery modes and a large number of unreal face images are provided for optimizing performance of the neural network.

In the present disclosure, a real face image included in the first dataset or the second dataset may be obtained by performing image acquisition on a real person's face. In some implementations, real face images included in an existing dataset also can be used as real face images included in the first dataset or the second dataset. For an unreal face image included in the first dataset or the second dataset, in some implementations, the unreal face image can be obtained by a target acquisition mode which can be understood as an image acquisition mode of forging real face image. By using the target acquisition mode, the number of unreal face images included in the first dataset or the second dataset can be expanded, and unreal face images included in the first dataset or the second dataset can be enriched.

In some examples, the target acquisition mode includes at least one of the following: one or more acquisition directions, one or more bending modes, and one or more types of one or more acquisition devices used to acquire unreal face images.

The acquisition directions for at least a portion of the unreal face images included in the same dataset are different; and/or, the bending modes for at least a portion of the unreal face images included in the same dataset are different; and/or, the types of acquisition devices corresponding to at least a portion of the unreal face images included in the same dataset are different.

In this example, the acquisition direction may indicate a relative direction between a normal vector of a shooting plane of an acquisition device and a plane of an unreal face. For example, an unreal face image can be obtained by acquiring an unreal face with a preset acquisition direction. In an implementation, acquisition directions for at least a portion of unreal face images included in the same dataset are different, such that acquisition directions for at least a portion of unreal face images included in the first dataset or the second dataset are different, which improves diversity of unreal face images.

For example, the acquisition direction may include the preset acquisition direction. The preset acquisition direction can be set as a direction in which a normal vector of the shooting plane of the acquisition device is perpendicular to the plane of the unreal face. The acquisition direction may also include a direction deviating from the preset acquisition direction with a preset angle of inclination. For example, a three-dimensional coordinate system can be established by taking a direction of a normal vector of a plane of an unreal face as a positive direction of the y-axis, where the positive direction of the y-axis corresponds to the preset acquisition direction, the direction deviating from the preset acquisition direction with a preset angle of inclination can be a direction in the xoy plane that is tilted by plus or minus 30 degrees from the positive direction of the y-axis; or it can be a direction in the yoz plane that is tilted by plus or minus 30 degrees from the positive direction of the y-axis. To ensure a relatively good quality of the unreal face images, the preset angle of inclination can be set within a certain range, for example, the preset angle of inclination can be set in a tilt angle range of [−30°, 30], such that an unreal face involved in an unreal face image may have a proper face size and a situation of an unreal face with an excessively small size caused by an excessive tilt angle may be reduced. The preset angle of inclination can be set in different angle ranges, and the specific angle range is not limited in the present disclosure. By setting a plurality of acquisition directions, unreal face images with different acquisition directions can be obtained, such that diversity of training samples included in the first dataset or the second dataset can be increased.

In this example, the bending mode may represent a bending way of an unreal face involved in an unreal face image. For example, an unreal face can be acquired after being bent in a preset bending direction to obtain an unreal face image. In an implementation, the bending modes for at least a portion of unreal face images included in the same dataset are different, such that the bending modes for at least a portion of unreal face images included in the first dataset or the second dataset are different, which improves diversity of unreal face images.

For example, the bending mode for an unreal face involved in an unreal face image includes at least one of the following: not bend; or bending in a preset bending direction. The preset bending direction can be set according to actual application scenarios. Assuming that an unreal face is not bent, a three-dimensional coordinate system can be established by taking a direction of a normal vector of a plane of the unreal face as a positive direction of the y-axis. The preset bending direction may be a positive direction of the x-axis (such as along the x-axis, bending to the positive direction of the y-axis) or a negative direction of the x-axis (such as along the x-axis bending to the negative direction of the y-axis), and the preset bending direction also may be a positive direction of the z-axis (such as along the z-axis, bending to the positive direction of the y-axis) or a negative direction of the z-axis (such as along the z-axis, bending to the negative direction of the y-axis). Furthermore, the preset bending direction also may be a positive direction of an axis tilted a certain angle from the x-axis (such as along the axis which deviates from the x-axis with the certain angle, bending to the positive direction of the y-axis) or a negative direction of the axis (such as along the axis which deviates from the x-axis with the certain angle, bending to the negative direction of the y-axis). By setting a plurality of bending modes for an unreal face involved in an unreal face image, unreal face images included in the first dataset or the second dataset can be enriched.

In this example, the target acquisition mode may include types of acquisition devices used to acquire unreal face images. Since different acquisition devices have different acquisition configurations, such as lens configuration, focal length setting, and other acquisition configurations, unreal face images acquired by different types of acquisition devices are also very different. In an implementation, types of acquisition devices corresponding to at least a portion of unreal face images included in the same dataset are different, therefore types of acquisition devices corresponding to unreal face images included in the first dataset or the second dataset are different. By setting different types of acquisition devices for unreal face images, unreal face images included in the first dataset or the second dataset can be further enriched. The types of acquisition devices include, but are not limited to, cameras, tablet computers with cameras, mobile phones with cameras, notebook computers with cameras, and so on.

In this example, a variety of target acquisition modes can be used for acquiring unreal face images, such that complexity and diversity of unreal face images included in the first dataset or the second dataset can be increased. Furthermore, by optimizing performance of the neural network with the unreal face images, the optimized neural network can be applicable to various application scenarios and accuracy of liveness detection can be improved.

It can be understood that the various method embodiments mentioned in the present disclosure can be combined with each other to form a combined embodiment without violating the principle and logic, which will not be elaborated here due to space limitations.

In addition, the present disclosure also provides apparatuses, electronic equipment, computer-readable storage media, and programs, all of which can be used to implement any of the methods of determining performance parameters provided by the present disclosure. The corresponding technical solutions and descriptions can refer to the corresponding records in the method section, which will not be elaborated here.

Those skilled in the art can understand that, in the above methods provided in the specific implementation, the writing order of the steps does not mean a strict execution order and does not constitute any limitation on the implementation process. The specific execution order of each step should be determined by its function and possible internal logic.

FIG. 3 is a block diagram illustrating an apparatus for determining performance parameters according to embodiments of the present disclosure. As shown in FIG. 3, the apparatus includes: a first acquiring unit 301 configured to acquire a first dataset which includes a plurality of face images; a detector 302 configured to, for each of the plurality of face images, input the face image into a neural network to obtain a liveness classification result and a detection result of the face image; and a determination unit 303 configured to determine performance parameters of the neural network according to a plurality of detection results.

In one or more possible implementations, the detection result comprises relevant data used to determine whether a face in the face image belongs to a living one or not.

In one or more possible implementations, the detection result comprises at least one of: a face attribute, a spoof type, an illumination condition, imaging environment, depth information, or reflection information.

In one or more possible implementations, wherein the plurality of face images comprise respective annotation information, the determination unit is also configured to, for each of the plurality of face images, obtain a comparison result corresponding to the face image by comparing the detection result of the face image with annotation information of the face image; and determine the performance parameters of the neural network based on comparison results corresponding to at least a portion of the plurality of face images.

In one or more possible implementations, the apparatus also includes a training unit, which is configured to, based on an evaluation result, acquire a plurality of training samples related to the evaluation result from a second dataset, wherein the training samples comprise face images, and the evaluation result is a result of evaluating the neural network according to the determined performance parameters; for each of the plurality of training samples, obtain a detection result of the training sample by inputting the training sample into the neural network; and adjust weight parameters of the neural network according to degree of difference between detection results with respect to at least a portion of the training samples and annotation information with respect to the at least a portion of the training samples.

In one or more possible implementations, the first dataset and the second dataset both comprise real face images and unreal face images, annotation information of a real face image comprises a liveness classification result and face attributes; and annotation information of an unreal face image comprises a liveness classification result and at least one of: a spoof type, an illumination condition, or imaging environment.

In one or more possible implementations, a number of the real face images in the second dataset is less than the number of the unreal face images in the second dataset.

In one or more possible implementations, the apparatus also includes a second acquiring unit, configured to obtain the unreal face images through a target acquisition mode.

In one or more possible implementations, the target acquisition mode comprises at least one of: one or more acquisition directions, one or more bending modes, or one or more types of one or more acquisition devices used to acquire the unreal face images.

In one or more possible implementations, the acquisition directions for at least a portion of the unreal face images comprised in a same dataset are different; and/or the bending modes for at least a portion of the unreal face images comprised in the same dataset are different; and/or the types of acquisition devices corresponding to at least a portion of the unreal face images comprised in a same dataset are different.

In some embodiments, the functions provided by or modules contained in the apparatus provided by embodiments of the present disclosure can be used to execute the methods described in the above method embodiments. For its specific implementation, reference may be made to the description of the above method embodiments, which will not be elaborated here for brevity.

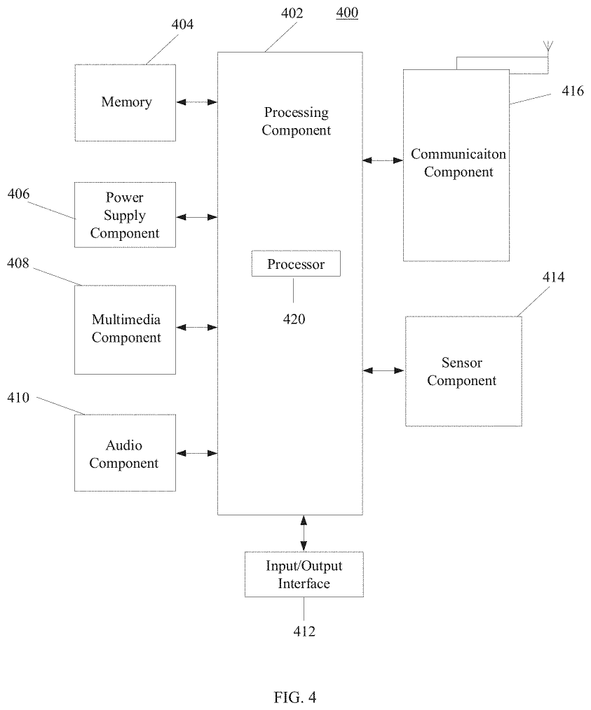

FIG. 4 is a block diagram illustrating a device 400 for determining performance parameters according to an exemplary embodiment. For example, the device 400 can be a mobile phone, a computer, a digital broadcast terminal, a message transceiver device, a game console, a tablet device, a medical device, a fitness device, a personal digital assistant, and the like.

Referring to FIG. 4, a device 400 may include one or more of the following components: processing component 402, memory 404, power supply component 406, multimedia component 408, audio component 410, input/output (I/O) interface 412, sensor component 414, and communication component 416.

Processing component 402 typically controls the overall operation of the device 400, such as operations associated with display, telephone calls, data communications, camera operations, and recording operations. Processing component 402 can include one or more processors 420 to execute instructions to perform all or part of the blocks of the above methods. Moreover, processing component 402 may include one or more modules to facilitate interaction between component 402 and other components. For example, processing component 402 may include a multimedia module to facilitate interaction between multimedia component 408 and processing component 402.

Memory 404 is configured to store various types of data to support operation of device 400. Examples of such data include instructions for any application or method operating on device 400, contact data, phone book data, messages, pictures, videos, and the like. The memory 404 may be implemented by any type of volatile or non-volatile storage device, or a combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, or optical disk.

Power supply component 406 provides power to various components of device 400. The power supply component 406 may include a power management system, one or more power sources, and other components associated with generating, managing, and distributing power for device 400.

The multimedia component 408 includes a screen that provides an output interface between the device 400 and the user. In some aspects, the screen may include a Liquid Crystal Display (LCD) and a Touch Panel (TP). If the screen includes a touch panel, the screen may be implemented as a touch screen to receive input signals from a user. The touch panel includes one or more touch sensors to sense touches, slides, and gestures on the touch panel. The touch sensor may not only sense the boundary of the touch or slide operation, but also detect the duration and pressure associated with the touch or slide operation. In some aspects, the multimedia component 408 includes a front camera and/or a rear camera. When the device 400 is in an operating mode, such as a shooting mode or a video mode, the front camera and/or the rear camera may receive external multimedia data. Each of the front and rear cameras may be a fixed optical lens system or have focal length and optical zoom capabilities.

The audio component 410 is configured to output and/or input an audio signal. For example, the audio component 410 includes a microphone (MIC) that is configured to receive an external audio signal when the device 400 is in an operating mode, such as a call mode, a recording mode, and a voice recognition mode. The received audio signal may be further stored in memory 404 or transmitted via communication component 416. In some aspects, the audio component 410 also includes a speaker for outputting an audio signal.

The I/O interface 412 provides an interface between the processing component 402 and a peripheral interface module, which may be a keyboard, a click wheel, a button, or the like. These buttons may include, but are not limited to, a home button, a volume button, a start button, and a lock button.

Sensor component 414 includes one or more sensors for evaluating state of various aspects of device 400. For example, sensor component 414 may detect on/off state of the device 400, relative locations of components, such as the display and keypad of device 400, and sensor component 414 may also detect a change in position of device 400 or one component of device 400, the presence or absence of user contact with device 400, orientation or acceleration/deceleration of the device 400, and temperature variation of device 400. The sensor component 414 may include a proximity sensor configured to detect the presence of nearby objects without any physical contact. The sensor component 414 may also include an optical sensor, such as a CMOS or CCD image sensor, for use in imaging applications. In some aspects, the sensor component 414 may also include an acceleration sensor, a gyroscope sensor, a magnetic sensor, a pressure sensor, or a temperature sensor.

Communication component 416 is configured to facilitate wired or wireless communication between device 400 and other devices. The device 400 may access a wireless network based on a communication standard, such as WiFi, 2G or 3G, or a combination thereof. In an exemplary aspect, the communication component 416 receives a broadcast signal or broadcast-associated information from an external broadcast management system via a broadcast channel. In an exemplary aspect, the communication component 416 also includes a Near Field Communication (NFC) module to facilitate short range communication. For example, the NFC module may be implemented based on Radio Frequency Identification (RFID) technology, Infrared Data Association (IrDA) technology, Ultra Wide Band (UWB) technology, Bluetooth (BT) technology, and other technologies.

In an exemplary aspect, the device 400 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGA), controller, microcontrollers, microprocessors or other electronic component to perform the above methods.

In an exemplary aspect, a non-transitory computer-readable storage medium is also provided, such as a memory 404 including computer program instructions, the computer program instructions may be executed by a processor 420 of the device 400 to cause the processor 420 to implement the above-described methods.

An embodiment of the present disclosure also provides an electronic device, which can include a processor; a memory for storing instructions executable by the processor; wherein the processor is configured to invoke the instructions to implement the above-mentioned methods.

The electronic device can be provided as a terminal, a server or a device of other form.

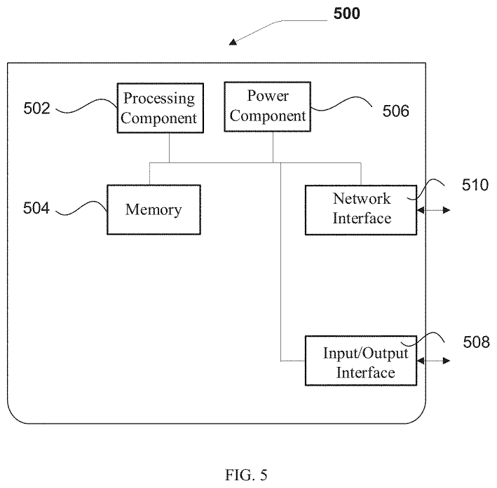

FIG. 5 is a block diagram illustrating an electronic device 500 according to an exemplary embodiment. For example, the electronic device 500 can be provided as a server. Referring to FIG. 5, an electronic device 500 may include a processing component 502 which further includes one or more processors, and memory resource represented by a memory 504 which is used for storing instructions executable by the processing component 502, for example the instructions may indicate application programs. The application program stored in the memory 504 may include one or more modules, each of the one or more modules corresponds to a set of instructions. In addition, the processing component 502 may be configured to execute instructions to implement the above-described methods.

The electronic device 500 may also include a power component 506 which is configured to perform power management on the electronic device 500, a wired or wireless network interface 510 configured to connect the electronic device 500 to a network, and an input/output (I/O) interface 508. The electronic device 500 can operate an operating system stored in the memory 504, such as Windows Server™, Mac OS X™, Unix™, Linux™, FreeBSD™ or the like.

In an exemplary embodiment, a non-transitory computer readable storage medium is also provided, such as a memory 504 including computer program instructions, the computer program instructions may be executed by the processing component 502 of the electronic device 500 to implement the above-described methods.

The present disclosure can be provided as a method, a system, and/or a computer program product. The computer program product may include computer-readable codes. When the computer-readable codes are run on a device, a processor in the device executes instructions for implementing the method of determining performance parameters. The computer-readable codes may store on the computer readable storage medium.

The computer-readable storage medium may be a tangible device that can hold and store instructions used by an instruction execution device. The computer-readable storage medium may be, for example, an electrical storage device, a magnetic storage device, an optical storage device, an electromagnetic storage device, a semiconductor storage device, or any suitable combination of the foregoing. More specific examples of the computer-readable storage media (non-exhaustive list) include: portable computer disks, hard disks, random access memory (RAM), read-only memory (ROM), erasable programmable read-only memory (EPROM or flash memory), static random access memory (SRAM), portable compact disk read-only memory (CD-ROM), digital versatile disk (DVD), memory stick, floppy disk, mechanical encoding device, such as punch cards with instructions stored thereon, protruding structure in the groove, and any suitable combination of the foregoing. The computer-readable storage medium used here is not interpreted as a transient signal itself, such as radio waves or other freely propagating electromagnetic waves, electromagnetic waves propagating via waveguides or other transmission media (for example, light pulses propagate via fiber optic cables), or electrical signals transmitted via wires.

The computer-readable program instructions described herein can be downloaded from a computer-readable storage medium to various computing/processing devices, or to an external computer or an external storage device via a network, such as the Internet, a local area network, a wide area network, and/or a wireless network. The network may include copper transmission cables, optical fiber transmission, wireless transmission, routers, firewalls, switches, gateway computers, and/or edge servers. The network adapter card or network interface in each computing/processing device receives computer-readable program instructions from the network, and forwards the computer-readable program instructions so that the computer-readable program instructions may be stored in the computer-readable storage medium of each computing/processing device.

The computer program instructions used to perform the operations of the present disclosure may be assembly instructions, instruction set architecture (ISA) instructions, machine instructions, machine-related instructions, microcode, firmware instructions, state setting data, or source code or object code written in one or more programming languages or any combination of thereof, the programing languages including object-oriented programming languages such as Smalltalk, C++, etc., and conventional procedural programming languages such as “C” language or similar programming languages. Computer-readable program instructions can be executed entirely on a user's computer, partly on the user's computer, executed as a stand-alone software package, partly executed on the user's computer and partly executed on a remote computer, or executed entirely on the remote computer or server. In a situation involving a remote computer, the remote computer can be connected to a user's computer through any kind of network, including a local area network (LAN) or a wide area network (WAN), or it can be connected to an external computer (for example, using an Internet service provider to connect to an external computer via the Internet). In some embodiments, an electronic circuit, such as a programmable logic circuit, a field programmable gate array (FPGA), or a programmable logic array (PLA), can be personalize customized by using status information of the computer-readable program instructions. The computer-readable program instructions are executed by the electronic circuit to realize various aspects of the present disclosure.

Various aspects of the present disclosure are described herein with reference to flowcharts and/or block diagrams of the methods, devices (systems) and computer program products in embodiments of the present disclosure. It should be understood that each block of the flowcharts and/or block diagrams, and combinations of blocks in the flowcharts and/or block diagrams can be implemented by computer-readable program instructions.

These computer-readable program instructions can be provided to processors of general-purpose computers, special-purpose computers, or other programmable data processing devices to produce a machine that produces a device that implements the functions/actions specified in one or more blocks in the flowcharts and/or block diagrams, when these instructions are executed by a processor of a computer or other programmable data processing device. It is also possible to store these computer-readable program instructions in a computer-readable storage medium. These instructions make computers, programmable data processing apparatuses, and/or other devices work in a specific manner. Thus, the computer-readable medium storing the instructions includes a manufacture, which includes instructions for implementing various aspects of the functions/actions specified in one or more blocks in the flowcharts and/or block diagrams.

It is also possible to load the computer-readable program instructions onto a computer, other programmable data processing device, or other equipment, so that a series of operation steps are executed on the computer, other programmable data processing device, or other equipment to generate a computer-implemented process, such that the instructions executed on the computer, other programmable data processing apparatus, or other equipment can implement the functions/actions specified in one or more blocks in the flowcharts and/or block diagrams.

The flowcharts and block diagrams in the drawings show architectures, functions, and operations that may be implemented according to the system, the method, and the computer program product described in a plurality of embodiments of the present disclosure. In this regards, each block in the flowchart or block diagram may represent a module, a program segment, or a part of an instruction, and the module, the program segment, or the part of the instruction contains one or more executable instructions for realizing a specified logic function. In some alternative implementations, the functions marked in a block may also occur in an order which is different from the order marked in the drawings. For example, two consecutive blocks can actually be executed in parallel, or they can sometimes be executed in the reverse order, depending on the functions involved. It should also be noted that each block in the block diagram and/or flowchart, and a combination of the blocks in the block diagram and/or flowchart, can be implemented by a dedicated hardware-based system that performs specified functions or actions, or it can be realized by a combination of a dedicated hardware and computer instructions.

The embodiments of the present disclosure have been described above, and the above description is exemplary, not exhaustive, and is not limited to the disclosed embodiments. Without departing from the scope and spirit of the described embodiments, many modifications and changes are obvious to those of ordinary skill in the art. The choice of terms used herein is intended to best explain the principles, practical applications, or technical improvements of the technologies in the market, or to enable other ordinary skilled in the art to understand the embodiments disclosed herein.

1. A computer-implemented method, comprising:
acquiring a first dataset that comprises a plurality of face images;
for each of the plurality of face images, obtaining a liveness classification result and a detection result of the face image by inputting the face image into a neural network; and
determining performance parameters of the neural network according to a plurality of detection results of the plurality of face images.

2. The computer-implemented method according to claim 1, wherein the detection result comprises relevant data used to determine whether a face in the face image belongs to a living one or not.

3. The computer-implemented method according to claim 1, wherein the detection result comprises at least one of:
a face attribute,
a spoof type,
an illumination condition,
an imaging environment,
depth information, or
reflection information.

4. The computer-implemented method according to claim 1, wherein each of the plurality of face images comprises respective annotation information of the face image, and
wherein determining the performance parameters of the neural network according to the plurality of detection results of the plurality of face images comprises:
for each of the plurality of face images, obtaining a comparison result corresponding to the face image by comparing the detection result of the face image with the respective annotation information of the face image; and
determining the performance parameters of the neural network based on comparison results corresponding to at least a portion of the plurality of face images.

5. The computer-implemented method according to claim 1, further comprising:
evaluating the neural network according to the determined performance parameters to obtain an evaluation result;
based on the evaluation result, acquiring a plurality of training samples related to the evaluation result from a second dataset, wherein the plurality of training samples comprise face images;
for each of the plurality of training samples, obtaining a detection result of the training sample by inputting the training sample into the neural network; and
adjusting weight parameters of the neural network according to a degree of difference between detection results with respect to at least a portion of the training samples and annotation information with respect to the at least a portion of the training samples.

6. The computer-implemented method according to claim 5, wherein the first dataset and the second dataset both comprise real face images and unreal face images, and
wherein annotation information of a real face image comprises a liveness classification result and face attributes, and annotation information of an unreal face image comprises a liveness classification result and at least one of a spoof type, an illumination condition, or an imaging environment.

7. The computer-implemented method according to claim 6, wherein a number of the real face images in the second dataset is less than a number of the unreal face images in the second dataset.

8. The computer-implemented method according to claim 6, further comprising:
obtaining the unreal face images through a target acquisition mode.

9. The computer-implemented method according to claim 8, wherein the target acquisition mode comprises at least one of:
one or more acquisition directions,
one or more bending modes, or
one or more types of one or more acquisition devices used to acquire the unreal face images.

10. The computer-implemented method according to claim 9, wherein at least a portion of the unreal face images comprised in a same dataset are associated with at least one of:
different acquisition directions,
different bending modes, or
different types of acquisition devices.

11. An electronic device, comprising:
at least one processor; and
one or more memories coupled to the at least one processor and storing programming instructions for execution by the at least one processor to perform operations comprising:
acquiring a first dataset that comprises a plurality of face images;
for each of the plurality of face images, obtaining a liveness classification result and a detection result of the face image by inputting the face image into a neural network; and
determining performance parameters of the neural network according to a plurality of detection results of the plurality of face images.

12. The electronic device according to claim 11, wherein the detection result comprises relevant data used to determine whether a face in the face image belongs to a living one or not.

13. The electronic device according to claim 11, wherein the detection result comprises at least one of:
a face attribute,
a spoof type,
an illumination condition,
an imaging environment,
depth information, or
reflection information.

14. The electronic device according to claim 11, wherein each of the plurality of face images comprise respective annotation information, and
wherein determining the performance parameters of the neural network according to the plurality of detection results of the plurality of face images comprises:
for each of the plurality of face images, obtaining a comparison result corresponding to the face image by comparing the detection result of the face image with the respective annotation information of the face image; and
determining the performance parameters of the neural network based on comparison results corresponding to at least a portion of the plurality of face images.

15. The electronic device according to claim 11, wherein the operations further comprise:
evaluating the neural network according to the determined performance parameters to obtain an evaluation result;
based on the evaluation result, acquiring a plurality of training samples related to the evaluation result from a second dataset, wherein the plurality of training samples comprise face images;
for each of the plurality of training samples, obtaining a detection result of the training sample by inputting the training sample into the neural network; and
adjusting weight parameters of the neural network according to a degree of difference between detection results with respect to at least a portion of the training samples and annotation information with respect to the at least a portion of the training samples.

16. The electronic device according to claim 15, wherein the first dataset and the second dataset both comprise real face images and unreal face images, and
wherein annotation information of a real face image comprises a liveness classification result and face attributes, and annotation information of an unreal face image comprises a liveness classification result and at least one of: a spoof type, an illumination condition or an imaging environment.

17. The electronic device according to claim 16, wherein a number of the real face images in the second dataset is less than a number of the unreal face images in the second dataset.

18. The electronic device according to claim 16, wherein the operations further comprise:
obtaining the unreal face images through a target acquisition mode, and
wherein the target acquisition mode comprises at least one of: one or more acquisition directions, one or more bending modes, or one or more types of one or more acquisition devices used to acquire the unreal face images.

19. The electronic device according to claim 18, wherein at least a portion of the unreal face images are associated with at least one of different acquisition directions, different bending modes, or different types of acquisition devices.

20. A non-transitory computer-readable storage medium coupled to at least one processor having machine-executable instructions stored thereon that, when executed by the at least one processor, cause the at least one processor to perform operations comprising:
acquiring a first dataset that comprises a plurality of face images;
for each of the plurality of face images, obtaining a liveness classification result and a detection result of the face image by inputting the face image into a neural network; and
determining performance parameters of the neural network according to a plurality of detection results of the plurality of face images.
